(19) United States
(12) Patent Application Publication
(10) Pub. No.: US 2010/0082424 A1
(43) Pub. Date: Apr. 1, 2010

(54) OFFLINE OPTIMIZATION OF ONLINE PROCESSES

(75) Inventors: Ramana Yerneni, Cupertino, CA (US); Chad Brower, Campbell, CA (US); Srinivasan Rajagopal, San Jose, CA (US); Jayavel Shanmugasundaram, Santa Clara, CA (US); Erik Vee, San Mateo, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/242,393

(22) Filed: Sep. 30, 2008

(51) Int. Cl. G06Q 30/00

(52) U.S. Cl. 705/14.43; 705/14.73

(57) ABSTRACT

Subject matter disclosed herein relates to a system for managing online resources, and in particular, to a system using an offline process to optimize the management of such online resources.

### BACKGROUND

1. Field

Subject matter disclosed herein relates to a system for managing online resources, and in particular, to a system using an offline process to optimize the management of such online resources.

2. Information

A technique for advertising on the Internet may include matching a targeted advertising campaign with Internet users that may be most likely interested in such advertising. For example, if an auto manufacturer is launching a new product, a preferred Internet audience may be one that visits Internet sites featuring automobiles. Though such advertiser-audience alignment is apparent in this example, in actual practice such an alignment may be much more complex.

Information regarding an Internet user may be obtained as the user navigates through multiple Internet sites, for example. Such a user may also have submitted personal data if enrolling into an online account for email, a chat site, an Internet group, and so on. A page view, or impression, open to such a user may present an opportunity for an advertisement.

Upon establishing one or more advertising campaigns, an advertising system may decide whether it is feasible to deliver a desired number of advertising opportunities with a desired advertising campaign target profile. Such a decision may, for example, be similar to a reservation system that considers a request and decides whether there is adequate supply to satisfy the request. However, unlike a general reservation system where a decision may be based on a relatively simple count of available inventory, decisions may be relatively difficult in an advertising system because pools of advertising opportunities satisfying advertising campaigns may intersect in complex ways. Deciding how to apportion such intersecting pools of advertising opportunities to various advertising campaigns may involve a combinatorial problem requiring a relatively large amount of time to solve, especially as the number of advertising campaigns grows. Accordingly, in an advertising system, it may be difficult to optimally decide which advertising campaigns to accept for processing and how to allocate advertising opportunities to them.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a diagram illustrating advertising campaigns and associated advertising opportunities, according to an embodiment.

FIG. 2 is a flow diagram of online and offline processes, according to an embodiment.

FIG. 3 is a schematic diagram of a system for allocating advertising inventory, according to an embodiment.

FIG. 4 is a schematic diagram illustrating an embodiment of a computing system.

### DETAILED DESCRIPTION

Some portions of the detailed description which follow are presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining” and/or the like refer to the actions and/or processes of a computing node, such as a computer or a similar electronic computing device, that manipulates and/or transforms data represented as physical electronic and/or magnetic quantities within the computing node's memories, registers, and/or other information storage, transmission, and/or display devices.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

In an embodiment, a supply of advertising opportunities may be allocated to a set of advertising campaigns that are capable of consuming or using such advertising opportunities. In a particular embodiment, an advertising opportunity may include a page view in a Web advertising system, a page view resulting from an Internet search, an Internet marketing site, and/or an email account, just to name a few examples. The Internet may provide multiple opportunities to specifically advertise to a particular target audience. For example, an advertiser may advertise airline tickets to a Web user searching the Internet for Hawaii vacation. In contrast, traditional advertising media, such as television, radio, and/or newspaper, for example, may not enable an advertiser to advertise to such a particular audience. Quantities of advertising opportunities may be regarded as advertisement inventories. An advertising campaign may include a process of advertising directed to a particular target audience. For example, an advertiser may engage in an advertising campaign to advertise a particular product to a particular group of consumers that are most likely to have an interest in purchasing the product, although claimed subject matter is not limited to such an example. In a particular example, an auto manufacturer of an expensive sports car may engage in an advertising campaign to advertise to young drivers having a relatively high income.

In an embodiment, and advertising campaign may specify, and be defined by a profile of one or more Internet users; a quantity of the one or more Internet users; and a time period for when the online advertising campaign is to target the one or more Internet users. For example, an Internet user profile may include user demographics, geographic location of the user, the user's internet searches and behavior, and/or content context of Internet sites that the user may visit. Of course, these are merely examples of elements of an advertising campaign, and claimed subject matter is not so limited.

Multiple advertising campaigns may compete for an inventory of advertising opportunities. Such a competition or contention among multiple advertising campaigns may occur if target audiences for such advertising campaigns overlap. For example, an advertising campaign may target males between the ages of 20 and 30, while another campaign may target Californians between the ages of 25 and 35. Thus, a determination of how to allocate a supply of advertising opportunities to contending advertising campaigns may involve a relatively complicated analysis. In particular, given a set of advertising opportunities and a set of advertising campaign targets, an allocation problem may involve allocating advertising opportunities to advertising campaigns in such a way that individual advertising campaigns may be allocated advertising opportunities that they request. Accordingly, a solution to such an allocation problem may be used to allocate advertising opportunities to advertising campaigns. In a particular embodiment, such a problem may be solved relatively quickly for a relatively large set of advertising opportunities and a relatively large set of advertising campaigns. However, such a solution may be sub-optimal. Even so, such a solution may adequately satisfy an allocation process to quickly provide advertising opportunities to advertising campaigns.

In an embodiment, multiple subsystems of an advertising system may work together to allow relatively quick allocation decisions while processing advertising campaign reservations online. Here, an online process may refer to a real-time process and/or a process involving a network connection such as the Internet. For example, an admission control component may be one such subsystem that may process advertising campaign reservations online. Such allocation decisions may be good but not necessarily optimal with respect to accepting advertising campaigns that can be served by advertising opportunities. Accordingly, an online process to determine allocation decisions may be refined to optimize such a process, as described below.

In a particular embodiment, an optimization component may refine an online process by using an offline process from time-to-time. That is, such an optimization component may operate offline to reexamine advertising campaigns that were accepted earlier by an admission control component. Herein, such operation from time-to-time may mean “occasionally”, and such meaning is not limited to regularly intervals or time spans. An offline process may refer to a process removed from external processes involving a network connection such as the Internet, for example. For example, an online process may include a real-time process involving an advertising service and an advertiser interacting with an advertising system. In contrast, an offline process may include a computer platform processing information from memory and/or a database. Such information may have been gathered earlier during an online process, for example. An offline process need not be concerned with immediate, real-time procedures, as may be the case for an online process. An optimization component, during such an offline process, may solve a full-scale optimization problem for allocating a supply of advertising opportunities to advertising campaigns. An optimization component may take a relatively long time to solve such a complex advertising optimization problem and construct a corresponding optimal solution. A solution to such an optimization problem may then be used as a basis for future decision making by an admission control component.

In a particular implementation, an admission control component need not stop accepting new advertising campaigns during times if an offline optimization component determines an optimal allocation of a supply of advertising opportunities to advertising campaigns, for example. In order to improve system availability, an admission control component may continue to consider new advertising campaigns for allocation while the offline optimization component uses, for example, a snapshot of current and forecasted advertising campaigns and advertising opportunities.

In an embodiment, an offline optimization component may determine a solution to an advertising optimization problem using information collected from an admission control component. Such a solution may subsequently be fed back to an admission control component to provide such an admission control component with new, updated initial conditions to refine, e.g., improve, an online process that determines advertising allocation. Information collected from an admission control component may include an advertising opportunity forecast, an inventory of advertising campaigns, and/or a level of contention, or interference, among the inventory of advertising campaigns. In addition to refining an online process that determines advertising allocation, a particular allocation of advertising inventory may be revised based, at least in part, on a solution to the advertising optimization problem.

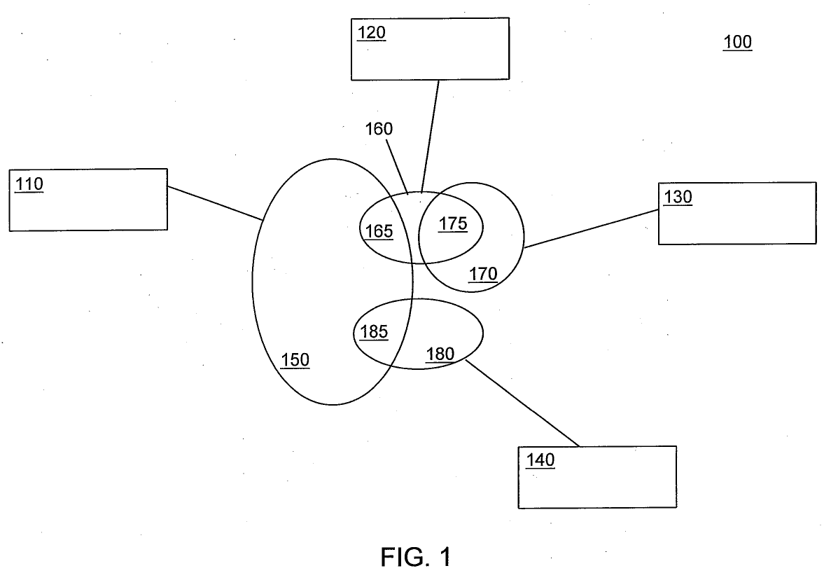

FIG. 1 is a diagram illustrating a sample of advertising campaigns and associated advertising opportunities, according to an embodiment. Such a sample 100 may include advertising campaigns 110, 120, 130, and 140 and associated advertising opportunities 150, 160, 170, and 180, respectively. An advertising campaign may include one or more processes initiated by an advertiser to provide information (e.g., an advertisement) to an audience targeted by virtue of their apparent interests. Apparent interests may be described in terms of criteria for a particular advertising campaign, for example. Such an audience may be associated with advertising opportunities, which may include websites, for example, visited by a target audience.

For example, advertising campaign 110 may define criteria that are substantially matched by advertising opportunity 150. In other words, advertising opportunity 150 may include targets that correspond to advertising campaign 110. However, a portion, or subset, of advertising opportunity 150 may also match advertising campaigns 120 and 140. For example, a subset 165 of advertising opportunity 160 overlaps with advertising opportunity 150. Such an overlap 165 among advertising opportunities may represent a contention among advertising campaigns 110 and 120. In other words, advertising campaigns 110 and 120 may be interested in the same pool, or subset 165, of advertising opportunities. Accordingly, an admission control component may determine an allocation of advertising inventory by considering such contention among advertising campaigns. Other contention subsets shown in FIG. 1 include overlap 175 among advertising campaigns 120 and 130 and overlap 185 among advertising campaigns 140 and 110.

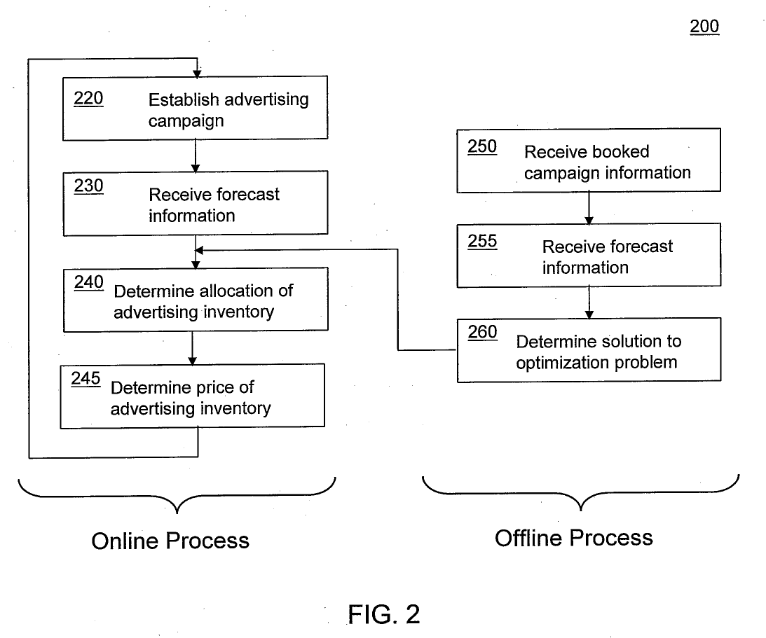

FIG. 2 is a flow diagram of an advertising allocation process 200 shown as online and offline processes, according to an embodiment. At block 220, an advertising campaign request may be received online, for example. Such a request may include criteria to define a set of advertising opportunities. Of course, such a request need not be received online, and claimed subject matter is not so limited. In a particular implementation, an admission control component may receive and establish an advertising campaign. At block 230, forecast information regarding available advertising opportunities and other advertising campaigns may be received from a supply forecasting component, for example. Such a supply forecasting component may communicate with an admission control component, though claimed subject matter is not so limited. At block 240, an admission control component may determine an allocation of advertising inventory. Such a determination may be based, at least in part, on forecast information received at block 230.

As mentioned above, advertising allocation process 200 includes an online process, which further includes blocks 220, 230, 240, and 245. Accordingly, processes of blocks 220, 230, 240, and 245 may occur over a relatively short time, such as seconds or minutes. For example, an advertising sales representative may respond to a new advertiser's inquiry about advertising opportunities. Such an exchange of information between the sales representative and the new advertiser may be aided by an online admission control component that may determine advertising opportunities and/or price for an advertising campaign in real time, in a period a seconds. Of course, such an online process is merely an example, and claimed subject matter is not so limited.

Continuing with process 200, at blocks 250 and 255, an offline optimization component, in a particular embodiment, may receive booked advertising campaign information and/or forecast information from a supply forecasting component. Such forecast information may include advertising opportunity forecasts and advertising campaign forecasts, for example. Such an offline optimization component may also receive other information, such as historical advertising information, just to name an example. At block 260, an optimization component may engage in determining a solution to an optimization problem for allocating a supply of advertising opportunities to advertising campaigns. The optimization component may utilize information that it receives from a supply forecasting component to determining a solution to an optimization problem.

Processes at blocks 250, 255, and 260 may be offline processes. Accordingly, such processes, in an embodiment, may occur over a relatively long time, such as hours. Such a relatively long time may allow a process at block 260, for example, enough time to determine a solution to an optimization problem for allocating a supply of advertising opportunities to advertising campaigns. Such a solution may include a set of values or other information that may be fed back to an online process, such as block 240, as shown in FIG. 2. Accordingly, at block 240, an allocation of advertising inventory may be determined using a solution to an optimization problem, so that such an allocation may be improved from an earlier process at block 240. Such an offline process may occur from time-to-time, and/or periodically, such as nightly for two to eight hours, during low-activity periods, and/or one or twice a week, just to mention a few examples. Of course, such an offline process is merely an example, and claimed subject matter is not so limited.

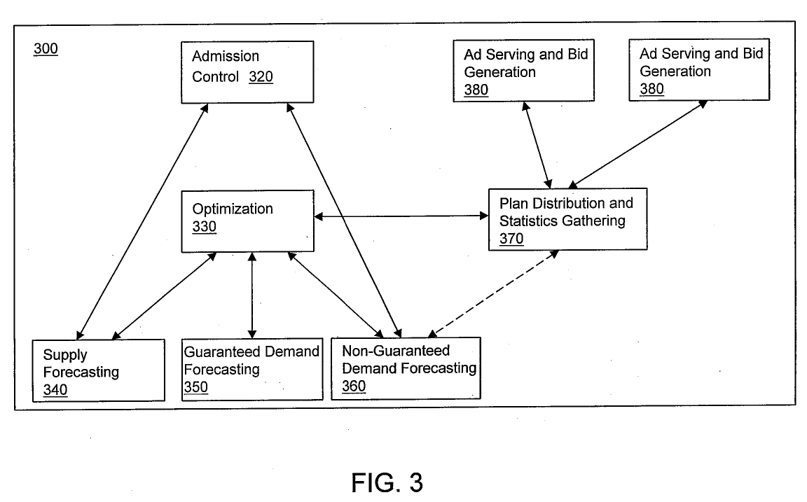

FIG. 3 is a schematic diagram of a system 300 for allocating advertising inventory, according to an embodiment. An admission control component 320 may interact with sales persons, for example, that sell guaranteed contracts to advertisers. Using admission control component 320, a sales person may issue a query to system 300 with a specified target. For example, such a query may include Internet users that browse a finance website and are California males who like sports and autos. Admission control component 320 may return information regarding available advertising inventory for the target and an associated price. The sales person may then book a contract with the advertiser accordingly. An ad server component 380 may receive an opportunity, which may include a user, the context of the user, a webpage visited by the user, and/or other targeting attributes, and return a guaranteed advertisement for the opportunity. Ad server component 380 may also return a price that system 300 is willing to bid for the opportunity. Of course, such a contract querying/booking process and advertisement serving process is merely an example, and claimed subject matter is not so limited.

In an embodiment, a process of system 300 may include an optimization component 330 that may operate offline to reexamine advertising campaigns that were accepted earlier by admission control component 320. Optimization component 330 may provide a solution to an optimization problem to admission control component 320, as explained below. Such a solution may be used by admission control component 320 to update initial conditions to refine an online process, as described above.

In an embodiment, optimization component 330 may from time-to-time receive a forecast of advertising supply, or future impressions, from supply forecasting component 340. Here, an impression may include a web page view, for example. Additionally, optimization component 330 may also receive information regarding guaranteed advertising demand (expected guaranteed contracts) from guaranteed demand forecasting component 350, and also receive information regarding non-guaranteed demand (expected bids in a spot market, for example) from non-guaranteed demand forecasting component 360. Optimization component 330 may match advertising supply to demand using an overall objective function, which may consider forecasts of advertising supply, guaranteed advertising demand, and non-guaranteed demand. For example, goals of an objective function may include preserving as many high-value impressions/advertising opportunities as possible for future campaigns, minimizing the number of under-allocated campaigns, and/or ensuring that campaigns get a uniform and representative allocation of advertising opportunities that satisfy their specified target. The optimization component 330 may then send a summary plan of an optimization result to admission control component 320 and to a plan distribution and statistics gathering component 370. Such a summary plan of an optimization result may be referred to as a solution to an optimization problem, as described above. Plan distribution and statistics gathering component 370 may then send such a solution to individual ad server components 380. The solution to the optimization problem provided by optimization component 330 may be updated from time-to-time and/or periodically, such as every few hours or so, based at least in part on availability of new estimates for advertising supply, demand, and delivered impressions.

To illustrate an embodiment, admission control component, such as admission control component 320 in FIG. 3, may operate as follows. If a sales person issues an advertising target query for some duration in the future, system 300 may invoke a supply forecasting component 340 to determine how much inventory may be available for the particular target and duration, for example. In a particular embodiment, targeting queries may be fine-grained, that is such queries may include a relatively high refinement of advertising targets that include a relatively large number of details. Accordingly, such targeting queries may be in a relatively high-dimensional space, so supply forecasting component 340 may use a scalable multi-dimensional database indexing technique, such as bit-map indices, to capture and store correlations between different targeting attributes, for example. However, capturing correlations among targeting attributes may only be one part of an optimization problem. Another part may involve contentions, e.g., interference, between multiple contracts. For example, two such interfering contracts may include “finance webpage users who are California males” and “general webpage users who are aged 20-35 and interested in sports”. In such a case, a solution to an optimization problem may include a determination of how many impressions match contracts associated with each interfering contract so that double-counting advertising inventory is avoided. In order to deal with such a contention in a high-dimensional space, supply forecasting component 340 may produce impression samples instead of merely providing available advertising inventory counts. In this fashion, samples of impressions may be used to determine how many contracts may be satisfied by each impression. Given such impression samples, admission control component 320 may use a solution to an optimization problem provided by optimization component 330 to calculate a contention between contracts in a high-dimensional space, and provide information regarding available inventory to sales persons without double-counting, for example. In addition, admission control component 320 may determine a price for individual contracts and quantities of available impressions and provide such information to a sales person. Of course, such a contract querying/booking process is merely an example, and claimed subject matter is not so limited.

Given a solution to an optimization problem, an ad server component, such as ad server component 380 in FIG.3, may operate according to an embodiment as follows. If an advertising opportunity is presented, ad server component 380 may calculate a contention among multiple contracts for an impression in a process similar to that of admission control 320. Ad server component 380 may be provided with such contention information and knowledge about non-guaranteed demand. Accordingly, ad server component 380 may select an advertising contract and generate a bid for the contract, both which may be sent to an exchange (not shown) to compete with other non-guaranteed contracts.

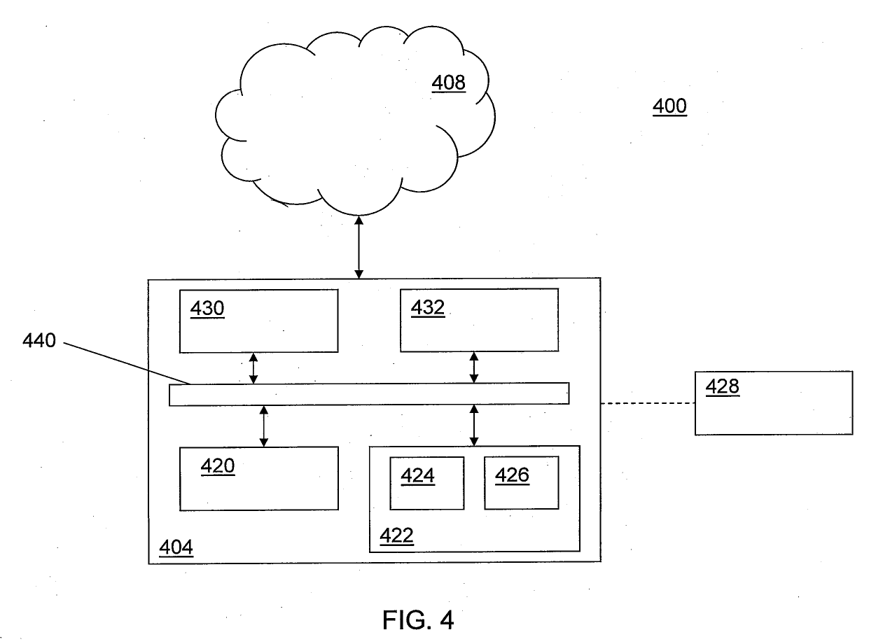

FIG. 4 is a schematic diagram illustrating an exemplary embodiment of a computing system 400 that may include one or more devices configurable to process advertisement allocation, such as online advertisement allocation using one or more techniques illustrated herein, for example. Computing device 404, as shown in FIG. 4, may be representative of any device, appliance or machine that may be configurable to exchange data over network 408. By way of example but not limitation, computing device 404 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 408, as shown in FIG. 4, is representative of one or more communication links, processes, and/or resources configurable to support exchange of information between computing device 404 and other devices (not shown) connected to network 408. By way of example but not limitation, network 408 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

It is recognized that all or part of the various devices and networks shown in system 400, and the processes and methods as further described herein, may be implemented using or otherwise include hardware, firmware, software, or any combination thereof. Thus, by way of example but not limitation, computing device 404 may include at least one processing unit 420 that is operatively coupled to a memory 422 through a bus 440. Processing unit 420 is representative of one or more circuits configurable to perform at least a portion of a data computing procedure or process. By way of example but not limitation, processing unit 420 may include one or more processors, controllers, microprocessors, microcontrollers, application specific integrated circuits, digital signal processors, programmable logic devices, field programmable gate arrays, and the like, or any combination thereof.

Memory 422 is representative of any data storage mechanism. Memory 422 may include, for example, a primary memory 424 and/or a secondary memory 426. Primary memory 424 may include, for example, a random access memory, read only memory, etc. While illustrated in this example as being separate from processing unit 420, it should be understood that all or part of primary memory 424 may be provided within or otherwise co-located/coupled with processing unit 420.

Secondary memory 426 may include, for example, the same or similar type of memory as primary memory and/or one or more data storage devices or systems, such as, for example, a disk drive, an optical disc drive, a tape drive, a solid state memory drive, etc. In certain implementations, secondary memory 426 may be operatively receptive of, or otherwise configurable to couple to, a computer-readable medium 428. Computer-readable medium 428 may include, for example, any medium that can carry and/or make accessible data, code and/or instructions for one or more of the devices in system 400.

Computing device 404 may include, for example, a communication interface 430 that provides for or otherwise supports the operative coupling of computing device 404 to at least network 408. By way of example but not limitation, communication interface 430 may include a network interface device or card, a modem, a router, a switch, a transceiver, and the like.

Computing device 404 may include, for example, an input/output 432. Input/output 432 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 432 may include an operatively configured display, speaker, keyboard, mouse, trackball, touch screen, data port, etc.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A method via a computing platform, the method comprising:
determining an allocation of advertising inventory using an online process; and
refining said online process to allocate said advertising inventory using an offline process.

2. The method of claim 1, further comprising:
allocating at least a portion of said advertising inventory to one or more advertising campaigns.

3. The method of claim 2, wherein said refining said online process comprises:
determining a solution to an advertising allocation optimization problem using said offline process; and
feeding back said solution to said online process to determine a future allocation of advertising inventory using said online process.

4. The method of claim 3, wherein said fed back solution provides updated initial conditions to refine said online process.

5. The method of claim 4, wherein said solution to said advertising allocation optimization problem includes an inventory of said one or more advertising campaigns and/or a level of contention among a list of said one or more advertising campaigns.

6. The method of claim 1, further comprising:
determining a price for said advertising inventory based, at least in part, on said determined allocation.

7. The method of claim 2, further comprising:
defining said one or more advertising campaigns using demographics of one or more Internet users and/or user behavior of said one or more Internet users.

8. The method of claim 1, wherein said offline process is performed periodically.

9. An apparatus comprising:
a computing platform, said computing platform being adapted to:
determine advertising opportunities associated with advertising campaigns;
determine an allocation of advertising inventory using an online process, said determination based, at least in part, on said advertising opportunities associated with said advertising campaigns; and
determine a solution to an advertising allocation optimization problem using an offline process, said solution to refine said online process.

10. The apparatus of claim 9, wherein said computing platform is further adapted to: allocate at least a portion of said advertising inventory to one or more advertising campaigns.

11. The apparatus of claim 9, wherein said solution provides updated initial conditions to refine said online process.

12. The apparatus of claim 10, wherein said solution to said advertising allocation optimization problem includes an inventory of said one or more advertising campaigns and/or a level of contention among a list of said one or more advertising campaigns.

13. The apparatus of claim 10, wherein said computing platform is further adapted to:
define said one or more advertising campaigns using demographics of one or more Internet users and/or user behavior of said one or more Internet users.

14. The apparatus of claim 9, wherein said offline process is performed periodically.

15. An article comprising: a storage medium comprising machine-readable instructions stored thereon which, if executed by a computing node, are adapted to enable said computing node to:
determine an allocation of advertising inventory using an online process; and
refine said online process to allocate said advertising inventory using an offline process.

16. The article of claim 15, wherein said computing platform is further adapted to:
allocate at least a portion of said advertising inventory to one or more advertising campaigns.

17. The article of claim 16, wherein said machine-readable instructions, if executed by a computing platform, are further adapted to enable said computing platform to:
determine a solution to an advertising allocation optimization problem using said offline process; and
feed back said solution to said online process to determine a future allocation of advertising inventory using said online process.

18. The article of claim 17, wherein said fed back solution provides updated initial conditions to refine said online process.

19. The article of claim 18, wherein said solution to said advertising allocation optimization problem includes an inventory of said one or more advertising campaigns and a level of contention among a list of said one or more advertising campaigns.

20. The article of claim 15, wherein said machine-readable instructions, if executed by a computing platform, are further adapted to enable said computing platform to:
determine a price for said advertising inventory based, at least in part, on said determined allocation.
